(19) United States
(12) Patent Application Publication
(10) Pub. No.: US 2003/0110267 A1
(43) Pub. Date: Jun. 12, 2003

(54) Method for routing electronic information to a person using internet protocols

(75) Inventors: Andrew Kevin Prentice, Pleasanton, CA (US); Jonathan Griffiths, Fremont, CA (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/015,456

(22) Filed: Dec. 10, 2001

(51) Int. Cl. G06F 15/16

(52) U.S. Cl. 709/227

(57) ABSTRACT

The present invention, in accordance with one embodiment, is directed to a method for routing electronic information to a person using personal internet protocols, instead of to a device using device internet protocols as performed by systems of the prior art. By routing electronic information to a person, the present invention enables electronic information to be transmitted to a device which is known to be in close proximity to the intended recipient. According to one embodiment, the method of the present invention comprises the step of receiving, at a home agent, electronic information addressed to a personal internet protocol address. The home agent forwards the electronic information to a foreign agent, which is coupled to the home agent via Internet. The foreign agent forwards the electronic information to a personal internet protocol agent, which is associated with the personal internet protocol address. The personal internet protocol agent, which may be a computer terminal, telephone, fax machine, set-top box, etc., is associated with the personal internet protocol address upon the user registering with the personal internet protocol agent. The personal internet protocol agent provides the electronic information to a user associated with the personal internet protocol address. Thus, a user may register, by entering his personal internet protocol address with a first personal internet protocol agent, to receive information via Internet at that personal internet protocol agent. When the user leaves the proximity of the personal internet protocol agent, the user may register, by entering his personal internet protocol address with a second personal internet protocol agent, to continue receiving information via Internet at the second personal internet protocol agent.

### FIELD OF THE INVENTION

The present invention is directed to internet protocols. More particularly, the invention is directed to a system and method for routing electronic information to a person using a personal internet protocol address.

### BACKGROUND OF THE INVENTION

The Internet is widely used in order to receive information, such as e-mail messages, stock quotes, product data, and a vast array of other types of information. There are various devices which may be used by a person in order to receive this information via Internet. The most common way is to access the Internet using a computer terminal, either at home, work, or at any other conceivable location, and to receive the information at the computer terminal. The Internet may also be accessed via telephone, either wired or cellular, or via a fax machine. Other persons access the Internet via a set top box or WebTV.

Over the course of any given day, many people employ more than one of these devices for receiving information via Internet. The reason that several of these devices may be employed is due to the fact that a person is typically mobile. Thus, for instance, a person may receive information during the daytime via Internet by using a computer terminal at his place of business. In addition, the person may receive information during his commute via Internet by using a web-enabled, wireless telephone. Upon returning home, the person may receive information via Internet by using a computer terminal at his home or by using a webTV.

When information is requested by an Internet user, the system simply transmits the information to the device with a specified device IP (Internet Protocol) address, at which the request was initiated. However, there are many instances when information is not specifically requested by an Internet user or when requested information is not immediately transmitted. A well-known example of this is an e-mail message, since it is typically sent without the recipient's prior knowledge (i.e.—not at the recipient's request). For information like this, problems may arise due to the fact that the intended recipient's whereabouts at the time of transmission is unknown. For instance, an e-mail message which is sent to the recipient's e-mail box at his or her home computer terminal may not be received if the recipient is not in close proximity to the home computer terminal.

Thus, the information which is transmitted via Internet to a person is typically received at a device with a specified IP address, which is merely assumed to be in the proximity of the recipient. Because of the mobility of a person, this assumption is often incorrect. If the assumption is incorrect, and the recipient is not in the proximity of the device at the time that the information is transmitted, then the recipient will not receive the information at that time.

Thus, there is a need for an improved system and method for routing electronic information via Internet.

### SUMMARY OF THE INVENTION

The present invention, in accordance with one embodiment, is directed to a method for routing electronic information to a person using personal internet protocols, instead of to a device using device internet protocols as performed by systems of the prior art. By routing electronic information to a person, the present invention enables electronic information to be transmitted to a personal Internet Protocol terminal, which a user specifies by registering that terminal to receive communication intended for the user.

According to one embodiment, the method of the present invention comprises the step of receiving, at a home agent, electronic information addressed to a personal internet protocol address. The home agent forwards the electronic information to a foreign agent, which is coupled to the home agent via Internet. The foreign agent forwards the electronic information to a personal internet protocol terminal, which is associated with the personal internet protocol address. The personal internet protocol terminal, which may be a computer terminal, telephone, fax machine, set-top box, etc., is associated with the personal internet protocol address upon the user registering with the personal internet protocol terminal. The personal internet protocol terminal provides the electronic information to a user associated with the personal internet protocol address.

More specifically, a user may register, by entering a personal internet protocol address with a first personal internet protocol terminal, to receive information via Internet at that personal internet protocol terminal. When the user leaves the proximity of the personal internet protocol terminal, the user may register, by entering his personal internet protocol address with a second personal internet protocol terminal, to continue receiving information via Internet at the second personal internet protocol terminal. Whenever a user registers with a new personal internet protocol terminal, the personal internet protocol terminal communicates the personal internet protocol address to the foreign agent. The foreign agent then communicates the personal internet protocol address of the user to the home agent. In one embodiment, when electronic information, such as a data packet, is received at the home agent, the home agent encapsulates the electronic information for delivery to the foreign agent, which de-encapsulates the electronic information prior to providing it to the user at the personal internet protocol terminal.

The user may register with the personal internet protocol terminal by entering his personal internet protocol address (or an alias of the personal internet protocol address) with a keyboard, or by providing electronic identification data via an electronic media, or by scanning a unique characteristic of the user.

### BRIEF DESCRIPTION OF THE DRAWINGS

In the drawings, in which like reference characters denote similar elements throughout the several views:

FIG. 1 is a diagram that illustrates the salient features of a personal information routing system, in accordance with one embodiment of the present invention;

FIG. 2 is a block diagram of a personal Internet protocol terminal in accordance with one embodiment of the invention.

FIG. 3 is a block diagram of functional components of a personal Internet protocol terminal in accordance with one embodiment of the invention.

FIG. 4 is a flowchart that illustrates the steps that are performed prior to the transmission of electronic information to the intended recipient, according to one embodiment of the present invention; and

FIG. 5 is a flowchart that illustrates the steps that are performed in order to route electronic information to an intended recipient who has registered with a personal internet protocol agent, according to one embodiment of the present invention.

It is to be understood that the drawings are not necessarily drawn to scale, but that they are merely conceptual in nature.

### DETAILED DESCRIPTION OF THE DRAWINGS

The present invention, in accordance with one embodiment, is directed to a method for routing electronic information to a person using a personal internet protocol, as explained hereinafter. Thus, the present invention differs significantly from systems of the prior art, in which electronic information is routed to a specific device using device internet protocols.

By routing electronic information to a person rather than to a specific device, it is possible for the user to travel to any desired location and register a terminal in accordance with the present invention and receive the intended information. As is explained in greater detail below, the present invention enables electronic information to be transmitted to a device which is known to be in close proximity to the intended recipient.

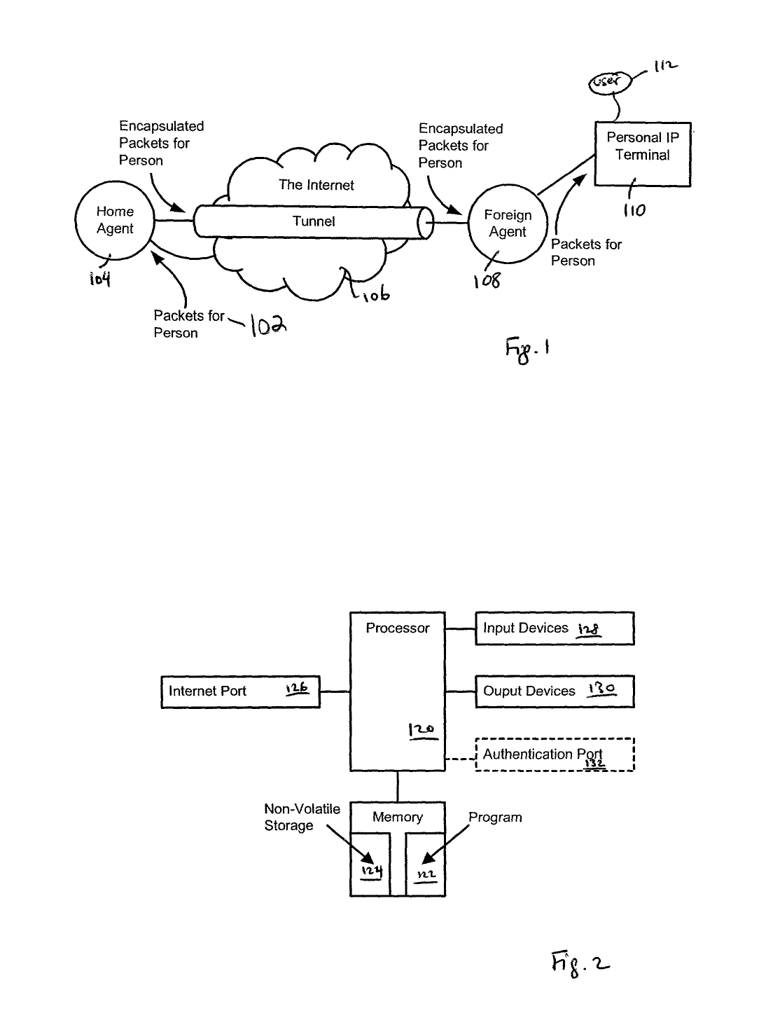

FIG. 1 is a diagram that illustrates the salient features of a personal information routing system of the present invention, in accordance with one embodiment thereof. Data packet 102 is a packet of data which is destined to be received by a recipient. Specifically, and as discussed in detail below, data packet 102 comprises a Personal internet protocol Address of an intended recipient. Data packet 102 is received by home agent 104. Home agent 104 is a data router, coupled to various other data routers via Internet 106 and configured to route data packets through Internet 106 to a final intended destination.

Foreign agent 108 is another such data router, which is also coupled to Internet 106 and is configured to route data packets. Personal internet protocol terminal 110 is coupled to foreign agent 108 and is configured to receive data packets therefrom. Personal internet protocol terminal 110 may comprise a computer terminal, telephone (wired or cellular), fax machine, set-top box, WebTV, PDA, or the like. User 112 is the intended recipient of electronic information and communicates with Personal internet protocol terminal 110.

In accordance with one embodiment of the invention, home agent 104 and foreign agent 108, employ data communication protocols as adopted by what is known as Mobile IP standard defined by The Internet Engineering Task Force (IETF) as described at www.ietf.org, and incorporated herein by reference.

Typically, Mobile Internet protocol is a scheme which enables a mobile node, such as a laptop computer, to be moved to a foreign link and still receive data packets addressed thereto. Specifically, Mobile Internet protocol employs the home agent and the foreign agent, which are coupled to each other via Internet. When a node is moved from a home agent (the data router to which the node is typically connected) to the foreign agent (the data router to which the node is temporarily connected), the node registers with the foreign agent.

The foreign agent provides the mobile node with a care-of address, which is transmitted to the home agent. Packets of data which are addressed to the mobile node are received by the home agent, encapsulated in a second packet of data addressed to the foreign agent, and forwarded to the foreign agent. This process is known as tunnelling. Once received, the foreign agent de-encapsulates the data packet and forwards it to the mobile node for display to the intended user.

Thus, schemes that employ Mobile internet protocol, route electronic information to devices. More specifically, schemes that employ Mobile internet protocol route electronic information to the internet protocol address of a device which is registered with the device's home agent via the foreign agent.

The registration of the internet protocol address of a device with the foreign agent has several disadvantages. For instance, a system that employs Mobile internet protocol can not insure that information transmitted to a device is actually received by the person for whom it was intended. In Mobile IP, the system does not know who registers the device with the system. Thus, when a laptop computer is registered with a foreign agent, the system does not know whether an authorized user of the laptop computer has registered it with the system or whether a different person has done so. Thus, the system merely assumes that the information that it transmits to the laptop computer will actually be received by the authorized user. If a different person is using the laptop computer, that different person will receive information which the system intended to be received by the authorized user of the laptop computer.

However, in accordance with one embodiment of the invention, a user provides a personal IP address to a personal Internet protocol terminal, and as such the terminal assumes that IP address for the duration of time that the user is registered with the terminal.

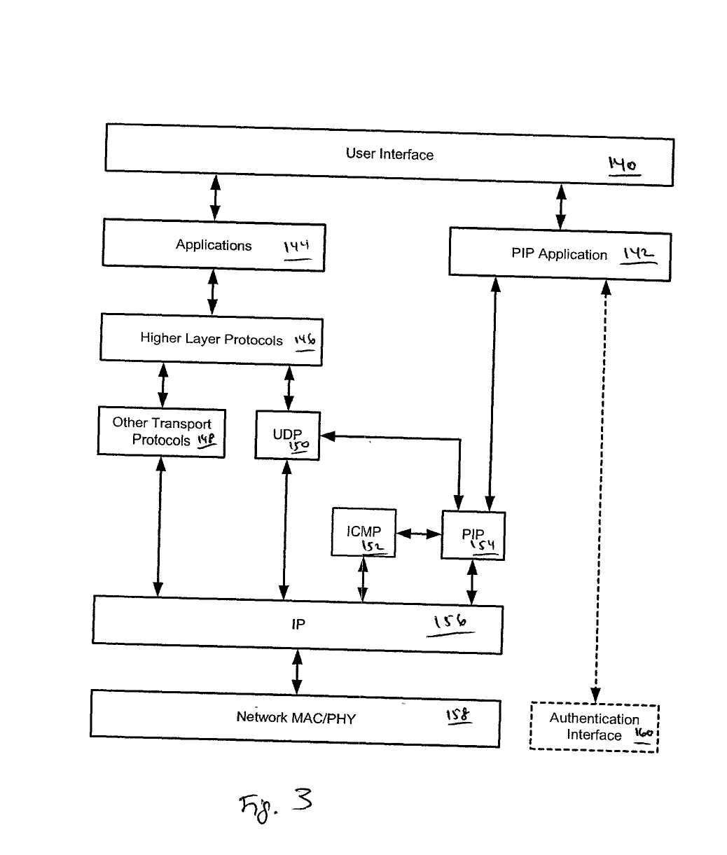

Referring now to FIG. 2, a Personal Internet Protocol terminal 110 in accordance with one embodiment of the invention is illustrated. A processor 120, is configured to maintain the operation of terminal 110, which may be any mobile device that adopts the functionality requirements of the personal internet protocol as discussed hereinafter.

Processor 120 is coupled to various peripheral devices, such as input devices 128, output devices 120, an Internet port 126, a memory unit 136 comprising a storage unit 124, such as a non-volatile memory, and a program storage unit 122. In accordance with one embodiment of the invention, processor 120 is also coupled to an authentication port 134.

Processor 120, in accordance with one embodiment of the invention is configured to run application programs that, among other things, implement the personal Internet protocol functionality and is any commercially available processor, such as an Intel x86, a PowerPC. Processor 120, in accordance with other embodiments of the invention is a digital signal processor, or a dedicated hardware or any combination of processing modules described above.

Input devices 128, in accordance with one embodiment of the invention, allows the user to enter information into personal internet protocol terminal 110, and may comprise, various typing and pointing devices, such as a keyboard, a mouse, and/or a touchscreen device. Other input devices include a microphone, a camera for recording video or still images, a scanner and a finger print or retinal scanner, for authorizing the user who intends to employ the terminal.

Output devices 130, in accordance with one embodiment of the invention, allows the user to extract information from terminal 110, and may comprise for example, speakers or headsets, a monitor, a TV screen or LCD display and a printer device.

Memory 136, in accordance with one embodiment of the invention is used to store data, such as temporary (volatile) data, permanent (non-volatile) data and programs for the processor. Memory 136 can be any type including, RAMs, such as SRAM, DRAM, SDRAM and FRAM.

Memory 136 also comprises ROMs, such as EPROM, EEROM, PROM and FlASH. Also included is storage devices, such as hard disks, floppy disks, CD-ROM, or a combination of these memory devices.

Internet port 126 is configured to provide a connection to the Internet. Examples of input port 126 include, an Ethernet, a wireless LAN—such as IEEE 802., and Hyperlan. Internet port 126 may also include broadbaand connections, such as Cable modems and DSL lines. Internet Port 126 may also include a dial-up modem, and cellular modems.

Finally, authentication port 134, in accordance with one embodiment of the invention provides a connection to interface with an authentication device, so as to allow only authorized users to employ terminal 110 via the authentication device. Examples of interfaces include, but are not limited to, wireless interfaces, such as bluetooth, HomeRF, Zygbee and IrDA. Other interfaces include PC Cards, such as PCMCIA, Cardbus and Mini PCI. Other interfaces include memory cards, such as Smart Cards, Compact Flash, and SIM cards. Further interfaces include removable media, such as CD-ROMs, DVD-ROMs, and floppy disks. In accordance with one embodiment of the invention, all these authentication devices include information corresponding to one or more users, that allow the user to identify itself to terminal 110 automatically, as explained hereinafter.

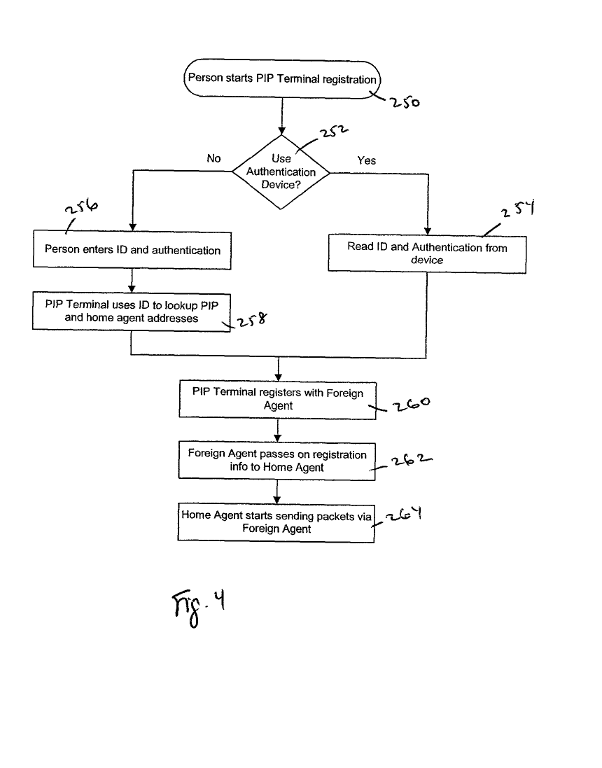

FIG. 3 is a block diagram of various functional components of personal Intenert protocol terminal 110, in accordance with one embodiment of the present invention. In accordance with one embodiment of the invention these functional components are embedded within terminal 110 as software and/or hardware components and the invention is not limited in scope in that respect.

As such FIG. 3 illustrates a user interface module 140 that handles all user interactions with terminal 110, via input and output devices 128 and 130 respectively. User interface module 140 is coupled to an applications module 144 and personal Internet protocol application module 142.

Personal Internet protocol application module 142 is configured to receive and store a user's assigned Internet protocol address, as the user registers with terminal 110. Personal Internet application module is also coupled to an authentication interface unit 160, which is configured to control authentication port 134. Personal Internet protocol application module 142 is also coupled to a personal internet protocol handler 154. The personal Internet protocol handler 154, is configured to provide the registered user's IP address to other components of terminal 110.

Applications module 144 is coupled to higher layer protocols handler 146, which is configured to perform HTTP and SSL functions of terminal 110. Higher layer protocols handler 146 is coupled to a Universal Datagram protocol (UDP) handler 150 and to transport protocol handler 148, both of which being coupled to Internet protocol handler 156. It is noted that UDP handler 150 is configured to handle source and destination IP addresses for messages sent and received via terminal 110.

UDP handler 150 is also coupled to personal Internet protocol unit 154, so as to receive IP addresses of users who register with terminal 110. Personal Internet protocol unit 154 performs the functions of encapsulating and decapsulating packets that are sent to and received by terminal 110, as well as registering terminal 110 with foreign agent 108 and home agent 104.

Personal Internet protocol unit 154 is also coupled to an Internet control and messaging protocol ICMP handler 152, which is configured to report errors in packets received by terminal 110, and also to perform diagnostics. ICMP handler 152 is coupled to Internet protocol handler 156, which is configured to handle packet routing functions. Internet protocol handler 156 is coupled to network physical layer handler 158, which is configured to send and receive packets over internet port 126.

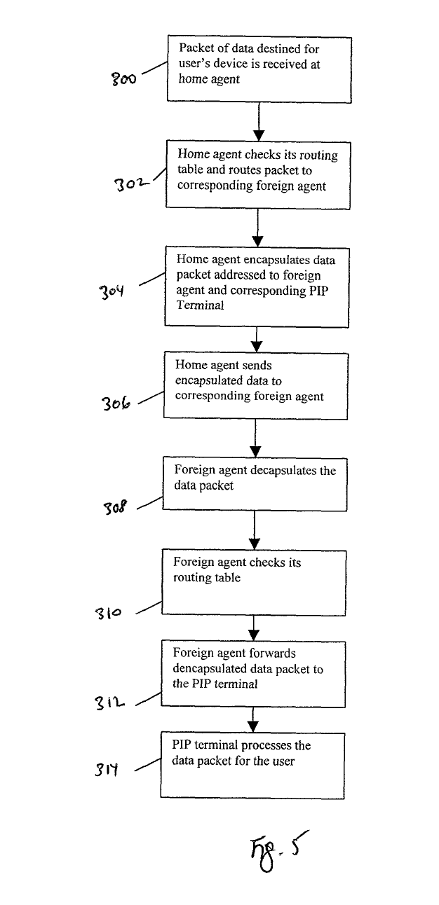

FIG. 4 is a flowchart that illustrates the steps that are performed, according to one embodiment of the invention, prior to the transmission of electronic information to the intended recipient. At step 200, a Personal internet protocol Address is assigned to a person. The present invention contemplates that the assignment of a Personal internet protocol Address to a person may be accomplished by any known method.

For instance, the present invention contemplates that the assignment of a Personal internet protocol Address to a person may be accomplished by the person registering with the system on-line, by telephone, by mail, or the like. The Personal internet protocol Address which is assigned to the person may be applicable to Internet Protocol Version 4, which employs 32 bit addressing, or else may be applicable to Internet Protocol Version 6, which employs 128 bit addressing. As is well known in the art, the use of 128 bit addressing provides for a greater number of possible addresses than does 32 bit addressing. As explained further below, the employment of a personal internet protocol address, instead of a device internet protocol address, provides for distinct advantages over the prior art systems.

At step 202, the person registers with Personal internet protocol terminal 110. The manner in which the person registers with Personal internet protocol terminal 110 depends, in part, on the type of device which is employed as the Personal internet protocol terminal. For instance, if Personal internet protocol terminal 110 provides an interface for a user to enter alphanumeric information (such as a computer terminal or handheld computing device having a keyboard; a telephone, fax machine or television remote control device having an arrangement of selectable buttons, etc.) the step of registration may be performed by the user entering a user name or number (user ID), a password or personal identification number (“PIN”) or the like. The user name or number, password or PIN may be the personal internet protocol address of the user or may be an alias for the personal internet protocol address of the user, as is well known in the art. During this registration stage, the user's home agent address is also stored and correlated with the user's ID.

At step 204, Personal internet protocol Agent 110 communicates the Personal internet protocol Address to Foreign Agent 108 via Internet 106. At step 206, Foreign Agent 108 updates its routing table to include the Personal internet protocol Address. At step 208, Foreign Agent 108 communicates the Personal internet protocol Address to Home Agent 104 via Internet 106. At step 210, Home Agent 104 updates its routing table to include the Personal internet protocol Address. Thus, when Home Agent 104 receives a data packet which is addressed to the personal internet protocol address of a user, Home Agent 104 knows to forward the data packet to Foreign Agent 108, as explained in greater detail below.

FIG. 5 is a flowchart that illustrates the steps that are performed, so that a user is enabled to register with a remote personal Internet protocol terminal such as 110, allowing the use of the terminal as if it were coupled to user's home agent 104.

At step 250, the user starts the process of registering with terminal 110. At step 252, terminal 110 determines whether an authentication device is used for the user registration. If so, terminal 110 at step 254 proceeds to read user's ID and authentication information, from the authentication device. For instance, the system may have a database of fingerprint scans, retinal scans, or the like, wherein each fingerprint or retinal scan is cross-referenced to the personal internet protocol address of a user. Thus, when a user registers at step 252 by scanning his fingerprint or retina, the system compares the scanned data to the stored data of the user, and upon verifying the user's identity, retrieving from the system's database the personal internet protocol address of the user.

In still another embodiment, Personal internet protocol termianl 110 provides an interface for receiving electronic identification data assigned to the user at step 250 (such as a device configured to read magnetically-stored data in the magnetic strip of a SmartCard, IrDA Identifier, RF Tag, Bluetooth Identifier. In this embodiment, the step of registration may be performed by the system reading the electronic identification data and associating it with the user.

At this point, terminal 110, via modules 160 and 142, record the user's IP address. The terminal, thereafter, at step 260 registers with foreign agent 108, based on the user's ID and authentication.

In still another embodiment, Personal internet protocol terminal 110 provides an interface for receiving electronic identification data assigned to the user at step 250 (such as a device configured to read magnetically-stored data in the magnetic strip of a SmartCard, IrDA Identifier, RF Tag, Bluetooth Identifier. In this embodiment, the step of registration may be performed by the system reading the electronic identification data and associating it with the user.

If however, at step 252, it is determined that an authentication device is not employed, then at step 256, the user is prompted to input the ID and authentication information via user interface module 140. At step 258, terminal 110 uses the ID information to look up the home agent IP addresses corresponding to the user ID.

At step 260, terminal 110 registers with foreign agent 108, and at step 262, foreign agent 108 passes on registration information to home agent 104. Thereafter, at step 264, home agent 104 begins sending packets to the user via foreign agent 108 and terminal 110.

It is noted that terminal 110 in effect assumes a different IP address every time a user registers with the user's IP address. As such, in accordance with one embodiment of the invention, terminal 110 employs Mobile IP version 6 standards to allow terminal 110 to inform its correspondents of its care-of address directly, thus avoiding the need for the home agent.

FIG. 6 is a flowchart that illustrates the steps that are performed, according to one embodiment of the invention, in order to route electronic information to an intended recipient who has registered with Personal internet protocol terminal 110. At step 300, a packet of data addressed to the recipient's Personal internet protocol Address is receive at home agent 104. At step 302, home agent 104 checks its routing table and determines that the packet of data addressed to the recipient's personal Internet protocol address is to be routed to foreign agent 108. Home agent 104 is configured to make this determination because home agent 104 previously updated its routing table with this information, based upon a communication received from foreign agent 108, as explained before in connection with foreign agent and home agent registration steps.

At step 304, home agent 104 encapsulates the packet of data addressed to the recipient's personal Internet protocol address within a second packet of data which is addressed to foreign agent 108. At step 306, home agent 104 forwards the encapsulated data packet to foreign agent 108. The process of encapsulating a data packet and forwarding it in this manner is also referred to as “tunneling”.

At step 308, after having received the encapsulated data packet, foreign agent 108 de-encapsulates the data packet. Thus, the packet of data addressed to the recipient's personal Internet protocol address is removed from the second packet of data addressed to foreign agent 108. At step 310, foreign agent 108 checks its routing table and determines that the packet of data addressed to the recipient's personal Internet protocol Address is to be routed to personal Internet protocol terminal 110. Foreign agent 108 is configured to make this determination because Foreign Agent 108 previously updated its routing table with this information, based upon a communication received from personal Internet protocol terminal 110, as explained before.

At step 312, foreign agent 108 forwards the de-encapsulated data packet to Personal Internet protocol terminal 110. At step 314, Personal internet protocol terminal 110 processes the received de-encapsulated data packet for display to the intended recipient. As previously discussed, the data may be displayed to the recipient on a computer terminal, a telephone or fax machine, a set top box, etc.

Therefore, the present invention, in accordance with various embodiments thereof, has the advantage of enabling a user, by registering with a Personal internet protocol Address, to receive information via Internet at a device which is known to be in close proximity to the user.

The present invention also has the advantage of enabling the user to employ a single Personal internet protocol Address to register with any one of a plurality of devices configured to receive information via Internet. Thus, a mobile person, who has access to different Internet-enabled devices at different times can successively perform the registration process, employing a single Personal internet protocol Address, with the device to which he is in close proximity. For instance, a user in a first location may perform the registration process using a first device to enter his Personal internet protocol Address, in order to receive information via the Internet at that first device. Upon moving to a second location which is not in close proximity to the first location (or upon simply changing his preference for the device with which to receive information), the user may again perform the registration process using the second device to enter his Personal internet protocol Address, in order to receive information via the Internet at that second device.

The system of the present invention, as described above, improves upon prior art methods such as those employed by Mobile Internet Protocols. As described above, the present invention does not suffer from disadvantages associated with Mobile Internet protocols, because it employs a personal internet protocol address instead of a device internet protocol address. The personal internet protocol address can be kept in confidence by the person. Then, when the person registers with the system by using the personal internet protocol address, the system can insure that the person that registered is the person who is the intended recipient of the information to be sent. This security feature is enhanced further in embodiments of the invention which employ fingerprint or retinal scans (or electronic identification methods) since the user's personal internet protocol address is not entered by the user but is instead received from storage if and only if the user's unique characteristic (or magnetic code) is recognized by the system.

In accordance with another embodiment of the invention, terminal 110 which employs a personal internet protocol address for each user, enables itself to be used by more than one user to receive information via the Internet. For instance, according to one embodiment of the present invention, when a first person registers with the system by entering his personal internet protocol address using a laptop computer, for example, the system then forwards information to the first person via Internet to that laptop computer. A second person can simultaneously register with the system and terminal 110, by entering his personal internet protocol address using the same laptop computer, and the system will forward information to both the first and second persons via Internet to that same laptop computer. Thus, any number of persons can simultaneously use the same device to receive information via Internet.

Furthermore, according to one embodiment of the present invention, any number of persons can successively use the same device to receive information via Internet. For instance, as described above, when a first person registers with the system by entering his personal internet protocol address using a laptop computer, the system then forwards information to the first person via Internet to that laptop computer. Once the first person re-registers with a different device (e.g.—his cellular phone), the system then forwards information to the first person via Internet to that second device. A second person can then register with the system by entering his personal internet protocol address using the laptop computer, and the system will forward information to the second person via Internet to the laptop computer. The second person will not receive information intended for the first person, nor will the first person receive information intended for the second person, because each person has registered a different device for receiving their information. Thus, any number of persons can successively use the same device to receive information via Internet.

Furthermore, the present invention eliminates the requirement for registering with several different internet protocol addresses by employing a single Personal internet protocol address which registers the user, not merely a device. The single personal internet protocol address is used to register with any device which the user has at hand.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

What is claimed is:

1. A method for routing electronic information to a personal Internet protocol terminal, said method comprising the steps of:
receiving from a user a personal IP address associated with said user;
storing said personal IP address as an IP address of said personal Internet protocol terminal;
registering said personal Internet protocol terminal with a foreign agent configured to receive data packets intended to said Internet protocol terminal;
providing said personal IP address to a home agent said home agent coupled to a device with a device internet protocol address associated with said user; and
receiving from said foreign agent data packets routed from said home agent, said data packets addressed to said device internet protocol address associated with said user.

2. The method of claim 1, wherein said personal internet protocol terminal is associated with said personal internet protocol address upon said user registering with said personal internet protocol terminal.

3. The method of claim 2, wherein said step of said user registering with said personal internet protocol terminal further comprises the step of said user entering said personal internet protocol address with a keyboard.

4. The method of claim 2, wherein said step of said user registering with said personal internet protocol terminal further comprises the step of said user entering an alias of said personal internet protocol address with a keyboard.

5. The method of claim 2, wherein said step of said user registering with said personal internet protocol terminal further comprises the steps of:
obtaining characteristic data from said user by scanning a characteristic of said user with a scanner;
matching said scanned characteristic data of said user with user characteristic data previously stored in a database; and
associating with said user a personal internet protocol address corresponding to the matching scanned characteristic data.

6. The method of claim 5, wherein said step of scanning a characteristic of said user further comprises the step of scanning a fingerprint of said user.

7. The method of claim 5, wherein said step of scanning a characteristic of said user further comprises the step of scanning a retina of said user.

8. The method of claim 2, wherein said step of said user registering with said personal internet protocol terminal further comprises the steps of:
said user providing electronic identification data stored on an electronic media; and
associating with said user a personal internet protocol address corresponding to said electronic identification data.

9. The method of claim 1, further comprising the step of, upon said user registering said personal internet protocol address with said personal internet protocol terminal, said personal internet protocol terminal communicating said personal internet protocol address to said foreign agent.

10. The method of claim 9, further comprising the step of, upon said personal internet protocol terminal communicating said personal internet protocol address to said foreign agent, said foreign agent communicating said personal internet protocol address of said user to said home agent.

11. The method of claim 1, further comprising the step of:
prior to said home agent forwarding said electronic information to said foreign agent, said home agent encapsulating said electronic information in a data packet addressed to said foreign agent.

12. The method of claim 11, further comprising the step of, prior to said foreign agent forwarding said electronic information to said personal internet protocol terminal, said foreign agent de-encapsulating said electronic information from within said data packet addressed to said foreign agent.

13. The method of claim 1, further comprising the steps of:
associating a second personal internet protocol terminal with said personal internet protocol address by said user re-registering with said second personal internet protocol terminal;
receiving, at said home agent, subsequent electronic information addressed to said personal internet protocol address;
said home agent forwarding said subsequent electronic information to a second foreign agent;
said second foreign agent forwarding said subsequent electronic information to said second personal internet protocol terminal;
said second personal internet protocol terminal providing said subsequent electronic information to said user.

14. The method of claim 1, further comprising the steps of:
associating said personal internet protocol terminal with a second personal internet protocol address by a second user registering with said personal internet protocol terminal;
receiving, at a second home agent, subsequent electronic information addressed to said second personal internet protocol address;
said second home agent forwarding said subsequent electronic information to a second foreign agent;
said second foreign agent forwarding said subsequent electronic information to said personal internet protocol terminal; and
said second personal internet protocol terminal providing said subsequent electronic information to said second user.

15. A system for routing electronic information comprising:
a home agent configured to receive electronic information addressed to a personal internet protocol address;
a foreign agent coupled to said home agent via Internet and configured to receive from said home agent said electronic information;
a personal internet protocol terminal associated with said personal internet protocol address and configured to receive from said foreign agent said electronic information, said personal internet protocol terminal further configured to provide said electronic information to a user associated with said personal internet protocol address.

16. The system of claim 15, wherein said personal internet protocol terminal is associated with said personal internet protocol address upon said user registering with said personal internet protocol terminal.

17. The system of claim 16, wherein said personal internet protocol terminal further comprises a keyboard, and said system is further configured to enable a user to register with said personal internet protocol terminal by entering said personal internet protocol address with said keyboard.

18. The system of claim 16, wherein said personal internet protocol terminal further comprises a keyboard, and said system is further configured to enable a user to register with said personal internet protocol terminal by entering an alias of said personal internet protocol address with said keyboard.

19. The system of claim 16, further comprising:
a scanner configured to obtain characteristic data from said user by scanning a characteristic of said user;
a database configured to store reference characteristic data of users, wherein said system is configured to match said scanned characteristic data with said reference characteristic data and to associate with said user a personal internet protocol address corresponding to the matching scanned characteristic data.

20. The system of claim 19, wherein said scanner is a fingerprint scanner.

21. The system of claim 19, wherein said scanner is a retinal scanner.

22. The system of claim 16, further comprising:
an electronic media configured to store electronic identification data corresponding to a user, wherein said system is further configured to associate with said user a personal internet protocol address corresponding to said electronic identification data.

23. The system of claim 16, wherein said personal internet protocol agent is configured, upon said user registering said personal internet protocol address with said personal internet protocol terminal, to communicate said personal internet protocol address to said foreign agent.

24. The system of claim 23, wherein said foreign agent is configured, upon said personal internet protocol terminal communicating said personal internet protocol address to said foreign agent, to communicate said personal internet protocol address of said user to said home agent.

25. The system of claim 15, wherein said home agent is further configured, prior to said home agent forwarding said electronic information to said foreign agent, to encapsulate said electronic information in a data packet addressed to said foreign agent.

26. The system of claim 25, wherein said foreign agent is further configured, prior to said foreign agent forwarding said electronic information to said personal internet protocol terminal, to de-encapsulate said electronic information from within said data packet addressed to said foreign agent.

27. The system of claim 15, further comprising:
a second personal internet protocol terminal associated with said personal internet protocol address by said user re-registering with said second personal internet protocol terminal; and
a second foreign agent, wherein said home agent is configured to receive subsequent electronic information addressed to said personal internet protocol address and to forward said subsequent electronic information to said second foreign agent, and said second foreign agent is configured to forward said subsequent electronic information to said second personal internet protocol terminal in order to provide said subsequent electronic information to said user.

28. The system of claim 15, wherein said personal internet protocol terminal is associated with a second personal internet protocol address by a second user registering with said personal internet protocol terminal, and wherein said system further comprises:
a second home agent configured to receive subsequent electronic information addressed to said second personal internet protocol address and to forward said subsequent electronic information to a second foreign agent, and wherein said second foreign agent is configured to forward said subsequent electronic information to said second personal internet protocol terminal to provide said subsequent electronic information to said second use.
